(19) United States
(12) Patent Application Publication
(10) Pub. No.: US 2024/0134704 A1
(43) Pub. Date: Apr. 25, 2024

(54) DEVICE COHORT RESOURCE MANAGEMENT

(71) Applicant: Adobe Inc., San Jose, CA (US)

(72) Inventors: Ankur Dhir, Ghaziabad (IN); Prashant Dahiya, Sonipat (IN); Ankur Gupta, Noida (IN)

(73) Assignee: Adobe Inc., San Jose, CA (US)

(21) Appl. No.: 17/971,091

(22) Filed: Oct. 20, 2022

(51) Int. Cl. G06F 9/50; G06N 20/00

(52) U.S. Cl. CPC G06F 9/505; G06N 20/00

(57) ABSTRACT

Device cohort management techniques are described that are usable to control resource utilization by the devices. This is performable by managing usage together through grouping the devices through membership in a cohort. As a result, interaction with resources by the various devices is coordinated across the cohort, thereby improving device operation and user efficiency in resource usage by the devices.

### BACKGROUND

Users are exposed to an ever-increasing variety of devices that are usable as part of everyday life. Devices are configurable, for instance, as traditional computers (e.g., desktops, laptops), tablets (e.g., digital notebooks, digital readers), streaming devices (e.g., smart TVs and streaming sticks), mobile phones, wearables (e.g., smart watches, rings, bracelets), and so forth. Further, these device configurations are employable as part of a variety of usage scenarios independent of the device configurations, e.g., it is not uncommon for users to have both work and personal mobile phones, computers, etc. Because of this, conventional techniques used in support of resource interaction by the devices is often fragmented due to the complexity caused by the different configurations and usage scenarios. Accordingly, operational efficiency of these devices as well as user interaction with the devices is reduced.

### SUMMARY

Device cohort management techniques are described that are usable to control resource utilization by the devices. This is performable by managing usage together through grouping the devices through membership in a cohort. As a result, interaction with resources by the various devices is coordinated across the cohort, thereby improving device operation and user efficiency in resource usage by the devices.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ device cohort resource management techniques described herein.

FIG. 2 depicts a system in an example implementation showing operation of a cohort management system of FIG. 1 in greater detail.

FIG. 3 depicts a system continuing the example implementation of FIG. 2 showing operation of the cohort management system in greater detail.

FIG. 4 depicts an example implementation of a cohort graph that defines relationships of devices within a cohort.

FIG. 5 depicts an example implementation of resource management involving digital content control at a personal and cohort level.

FIG. 6 is a flow diagram depicting a procedure in an example implementation of device cohort resource management.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

Overview

Conventional user interaction involving devices is often fractured across the devices. For example, due to the variety of device configurations and variety of usage scenarios supported by these devices, it is difficult to coordinate resource usage across the devices. This hinders both operational and user efficiency as part of interaction with the resources by the devices.

Accordingly, device cohort management techniques are described that are usable to control resource utilization by the devices. This is performable by managing usage together through grouping the devices through membership in a cohort. As a result, interaction with resources by the various devices is coordinated across the cohort, thereby improving device operation and user efficiency in resource usage by the devices.

In an example, an input is received via a device involving interaction with a resource. A user input, for instance, is received involving interaction with an application executed the user's personal device. In response, a cohort of devices is detected by a cohort management system that have a shared characteristic that defines membership in the cohort. This is performable, for instance, by the cohort management system to locate other devices based on a geographic location, e.g., within a household. In another example, this is performed by the cohort management system using a machine-learning model trained using machine learning. This is used to identify the shared characteristic that is used to define the cohort, automatically and without user intervention. The machine-learning model, for instance, is trained using training data to locate other devices that share a shared characteristic that is usable to identify commonalities in usage of the resource for grouping the devices together.

Once the cohort of devices is detected, resource utilization data is obtained by the cohort management system. The resource utilization data includes resource scores describing respective amounts of resource utilization by devices included in the cohort of devices. The resource utilization data, for instance, is obtained from a recommendation engine that includes resource scores associated with respective resources, e.g., as a matrix. The resource scores are also associable with respective categories, i.e., are assigned to those categories using tags. In an implementation, the recommendation engine generates the resource scores using a machine-learning model. The machine-learning model is trained using training data to define the amounts based on a likely relevance of that resource as part of interaction by the respective device. A variety of other examples are also contemplated.

The cohort management system then generates impact data describing an impact of respective devices on resource utilization. An impact determination module, for example, is used to determine a category for a respective resource, locate devices in the cohort of device that have interacted with the resource, and adjust resources scores (e.g., apply a weighting) for that resource and/or category based on this history of interaction.

The adjusted resource scores are then filtered by the cohort management system using a score filtering module to locate resources based on a likelihood the resources pertain to shared involvement by the cohort of devices. Resources that do not have at least a threshold amount of this likelihood (e.g., a probability) are removed to form a set of filtered resource scores. In an implementation, the score filtering module filters the resource scores using a machine-learning model. The machine-learning model is trained using training data to define the amounts based on a likely relevance of that resource as involving shared interaction by the cohort of devices as a whole. A variety of other examples are also contemplated, e.g., through filtering based on tags in comparison with a list indicative of resources that have this likelihood and/or do not have a likelihood of shared interaction.

The filtered resource scores from the score filtering module are then assembled into buckets by a category assembly module. The category assembly module, for instance, collects resources scores for each resource across the devices in the cohort, which are “bucketized” together. The resource scores are then used to control resource utilization by the cohort of resources, such as to control which items of digital content are communicated to the devices, provisioning of hardware and software resources of a service provider system and/or the devices, and so forth. In this way, the cohort management system supports unified control of the devices for resources that have a likelihood of involving shared interaction by the devices. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

Example Environment

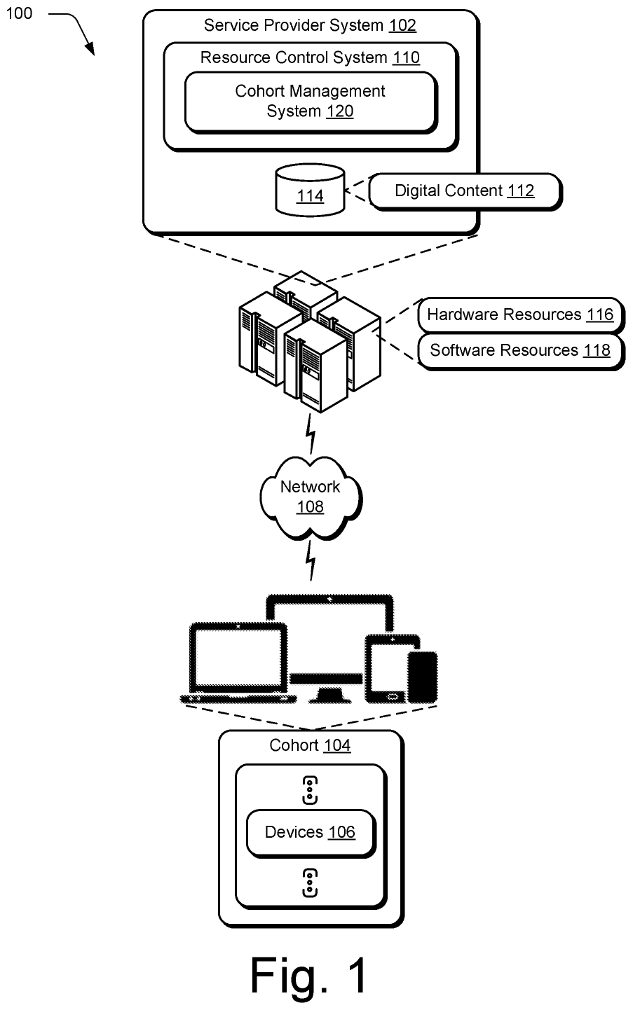

FIG. 1 is an illustration of a digital medium environment 100 in an example implementation that is operable to employ device cohort resource management techniques described herein. The illustrated environment 100 includes a service provider system 102 and a cohort 104 of devices 106 that are communicatively coupled, one to another, via a network 108. The service provider system 102 and devices 106 are configurable in a variety of ways, examples of which include computing devices.

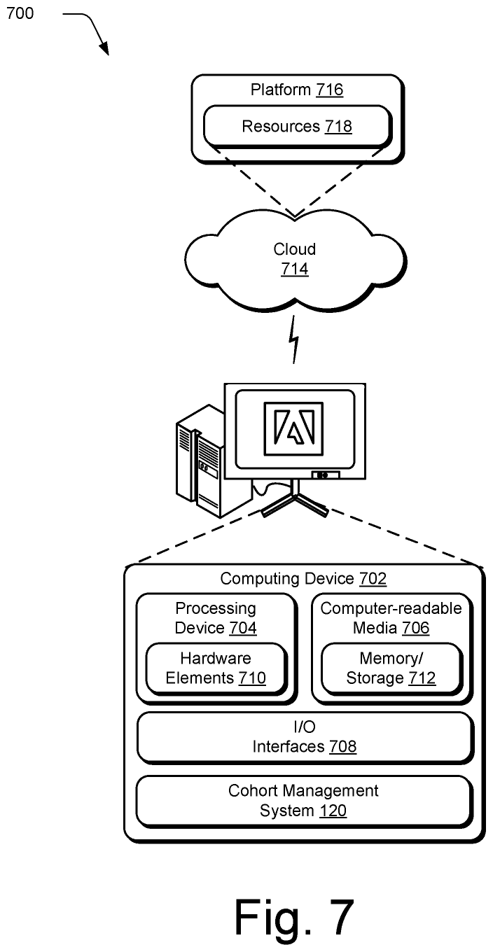

A computing device, for instance, is configurable as a desktop computer, a laptop computer, a mobile device (e.g., assuming a handheld configuration such as a tablet or mobile phone as illustrated), and so forth. Thus, computing devices ranges from full resource devices with substantial memory and processor resources (e.g., personal computers, game consoles) to a low-resource device with limited memory and/or processing resources (e.g., mobile devices). Additionally, although a single computing device is described in some instances, computing devices are also representative of a plurality of different devices, such as multiple servers utilized by a business to perform operations “over the cloud” as described in FIG. 7.

The service provider system 102 includes a resource control system 110 that is configured to manage resource utilization and allocation at the service provider system 102 and/or the devices 106 of the cohort 104. Examples of resources that are a subject of this management include digital content 112 from storage 114 (e.g., digital documents, digital images, digital media), hardware resources 116 and software resources 118 of the service provider system 102 used to provide the digital content 112, and so forth. Additional examples include communication of the digital content 112 that is also usable to control resource utilization at the devices 106, themselves, e.g., which devices are provided access to the digital content 112.

As previously described, conventional device interaction techniques are fractured, often due to a multitude of devices and user identifiers employed by even casual users in a variety of usage scenarios. To address these challenges, the resource control system 110 of the service provider system 102 includes a cohort management system 120 that is configured to support shared interaction with devices 106 based on inclusion in a cohort 104.

Consider an example involving a household having five devices belonging to four different users. These users often search for common products of interest on their personal devices. In conventional techniques, each device is provided a list of recommendations based on previous interaction with that device, e.g., a previous search history. Therefore, in order to support a shared experiences users are often faced with sharing a single device to view and share recommendations with each other, which is burdensome, involves the users to be available at a same time, and is difficult to perform.

To address these challenges, a cohort management system 120 is employed to detect a cohort 104 of devices 106. Membership in the cohort is based on a shared characteristic, e.g., geography in the current example. The cohort management system 120 is also configured to identify resources that have a likelihood of pertaining to shared involvement by the devices 106 in the cohort 104. Continuing the above example, users may gather around devices to search for items such as furniture, televisions, and so forth that likely are of interest to the group as a whole. Accordingly, the cohort management system 120 is configured to provide digital content (e.g., the resource in this example) to the devices 106 of the cohort 104 based on the devices 106 and previous resource utilization by the cohort 104 as a whole. In this way, individual usage of devices 106 within the cohort 104 is managed automatically and without user intervention to support resource utilization that are likely a subject of shared involvement by the devices 106. This improves efficiency of user interaction with the devices as well as increased accuracy and operation efficiency of the devices themselves. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Device Cohort Resource Management

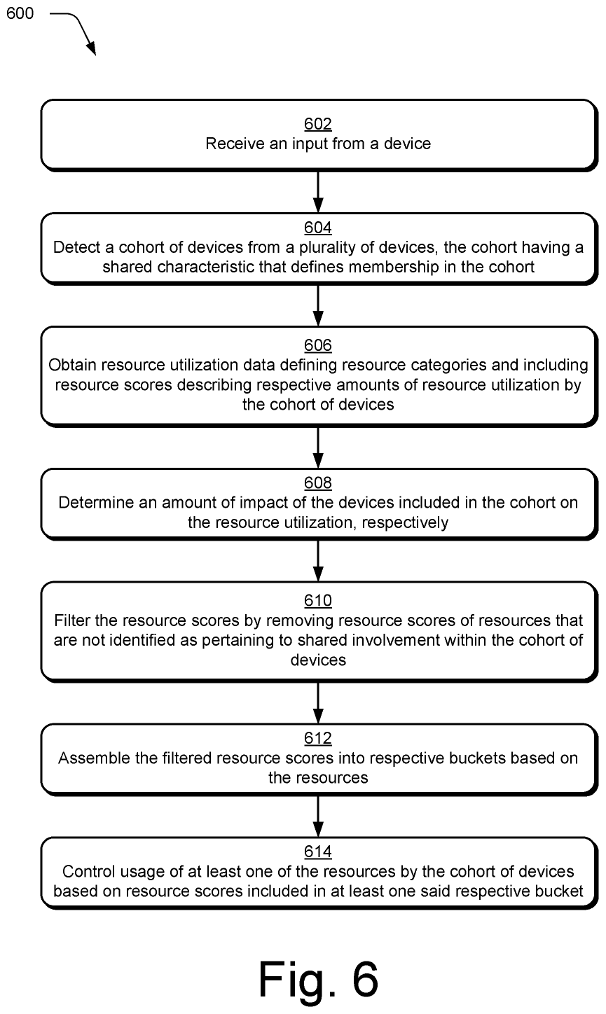

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5 in parallel with an example procedure 600 of FIG. 6. The following example is described in relation to device cohorts. These techniques are also applicable to a variety of other scenarios, including use of user identifiers (IDs) by a service provider system to management digital service utilization.

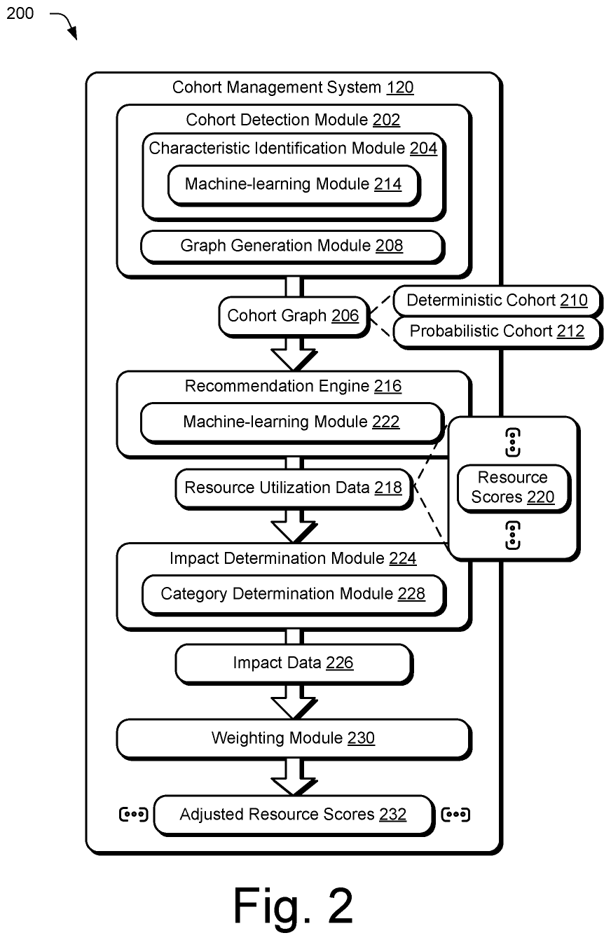

FIG. 2 depicts a system 200 in an example implementation showing operation of the cohort management system 120 of FIG. 1 in greater detail. To begin in this example, an input is received from a device (block 602). The input, for instance, involves user interaction with an application (e.g., browser, search engine, digital streaming application, etc.) executed by a respective device. The input, for instance, is received by the cohort management system 120 as a search query from one of the devices 106 via the network 108.

In response, a cohort 104 of devices is detected from a plurality of devices by a cohort detection module 202 of the cohort management system 120. The cohort 104 has a shared characteristic that defines membership in the cohort (block 604). To do so, the cohort detection module 202 identifies the shared characteristic using a characteristic identification module 204.

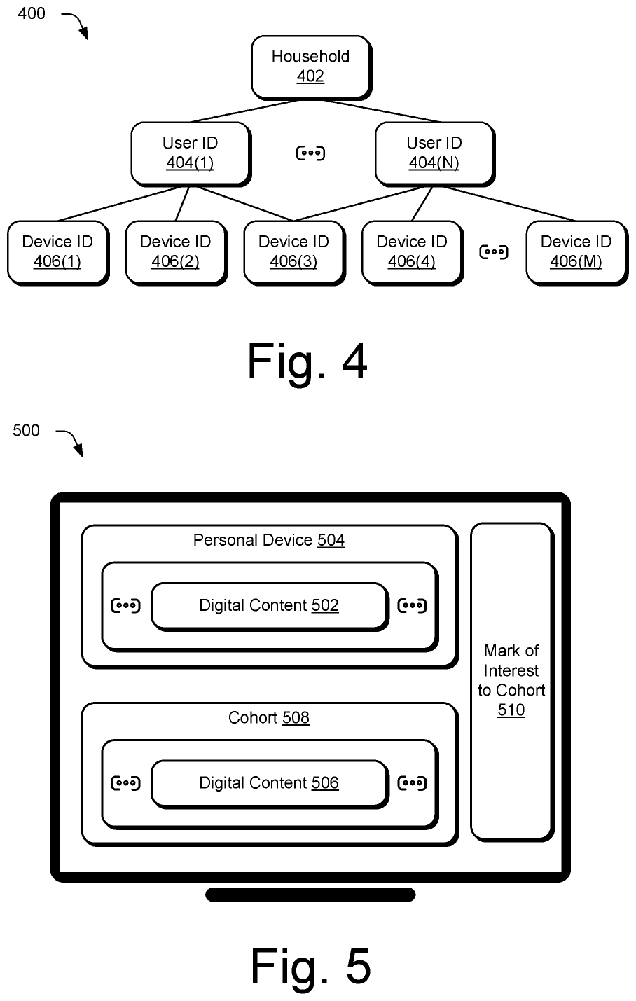

Continuing the previous example above, the characteristic identification module 204 identifies a shared characteristic and a graph generation module 208 generates a cohort graph 206 for the shared characteristic of devices associated within a same household that defines relationships of devices within a cohort. FIG. 4 depicts an example implementation 400 of the cohort graph 206 for a household 402 that is generated for user IDs 404(1), . . . , 404(N) and associated device IDs 406(1), 406(2), 406(3), 406(4), . . . , 406(M). The graph generation module 208 is configured to generate the cohort graph 206 in a variety of different ways, examples of which include as a deterministic cohort 210 and a probabilistic cohort 212.

In a deterministic example, the characteristic identification module 204 uses the shared characteristic to identify which devices 106 are included in the cohort 104. In the household example above, users 404(1)-404(N) are associated with user IDs as part of interacting with an application. Based on these user IDs, and associated account data (e.g., address, subscription information, and so on) it is determined that these IDs are included in a single household 402. From this, devices 406(1)-406(M) that correspond to those user IDs are identified as being included in that cohort.

In a probabilistic example, probabilities are determinable to identify which devices are to be included in the cohort and/or which shared characteristic is to be used to define the cohort 104. This is performable in a variety of ways, an example of which include machine learning, functionality of which is represented using a machine-learning module 214.

The machine-learning module 214 includes a machine-learning model trained using training data as part of machine learning. A machine-learning model refers to a computer representation that can be tuned (e.g., trained) based on inputs to approximate unknown functions. In particular, the term machine-learning model can include a model that utilizes algorithms to learn from, and make predictions on, known data by analyzing training data to learn to generate outputs that reflect patterns and attributes of the training data. Examples of machine-learning models include neural networks, convolutional neural networks (CNNs), long short-term memory (LSTM) neural networks, generative adversarial networks (GANs), decision trees, and so forth. In this example, the machine-learning model is trainable to identify the cohort 104 based on similarities of the device usage or the devices themselves to locate the shared characteristic usable to define membership in the cohort 104.

In the illustrated example, a recommendation engine 216 is configured to generate resource utilization data 218. In this way, the resource utilization data 218 is obtained that defines resource categories and including resource scores 220 describing respective amounts of resource utilization by the cohort 104 of devices 106 (block 606). The resource categories are includable as tags for respective resources.

The recommendation engine 216 also includes a machine-learning module 222, but in this instance is configured to generate the resource scores 220 for resources by respective devices 106. The resource scores 220, for instance, are configurable as indicative of a relative likelihood (e.g., probability) of resource interaction by a respective device with a respective resource. The machine-learning model of the machine-learning module 222 is therefore trained using training data in order to generate these probabilities, e.g., as a prediction of resource interaction. A variety of other examples are also contemplated.

An impact determination module 224 is then employed to determine an amount of impact of the devices 106 included in the cohort 104 on the resource utilization, respectively (block 608). The amount of impact, for instance, describes previous usage of the resource by the device based on respective categories as determined by a category determination module 228. The amount of impact is also usable to define an amount of impact the device has on resource usage by other devices, an amount of influence on those other devices. A variety of other examples are also contemplated.

The impact data 226 is then used by a weighting module 230 to generate adjusted resource scores 232 based on the influence. The adjusted resource scores 232, for instance, are weighted based on an influence of devices within the cohort and overall influence of the plurality of devices, e.g.,:

O FinalScore(item)=Eᵢ₌₁^{H}Score(i,item)*InfluenceScore(i,C)/Eᵢ₌₁^{H}InfluenceScore(i,C)

wherein “H” represents a number of devices or user IDs in a cohort, and “C” is the category of the resource.

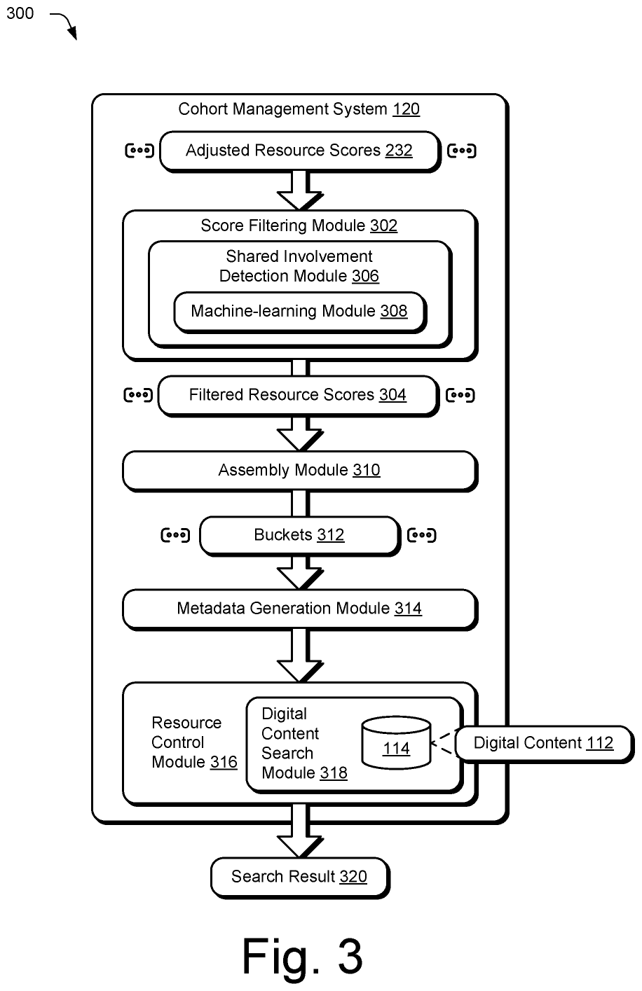

FIG. 3 depicts a system 300 continuing the explanation of the example implementation of FIG. 2 showing operation of the cohort management system 120 in greater detail. The adjusted resource scores 232 are received as an input by a score filtering module 302. In response, the resource scores are filtered by removing resource scores of resources that are not identified as pertaining to shared involvement within the cohort of devices (block 610) to generated filtered resource scores 304.

The score filter module 302 is configurable to perform the filtering in a variety of ways through use of a shared involvement detection module 306. In a first example, the resource scores 220 and corresponding resources are tagged in the resource utilization data 218. These tags provide semantic indications as to “what” is represented by respective resources. Accordingly, a list is used by the score filtering module 302 in this example that is indicative of which resources likely pertain to shared involvement. This is usable, in one example, using natural language understanding techniques in which a machine-learning module 308 is trained using training data to generate a text embedding space. Therefore, a closeness determination (e.g., least squares) is usable to determine which tags are within a threshold distance of text in the list to determine a likelihood that respective resources.

In another example, the machine-learning module 222 is trained using training data to determine which resources are likely to involve shared involvement. The training data, for instance, describes usage of respective devices with respective resources, and from this, the machine-learning module 308 is usable to learn a likelihood of which resources are part of shared involvement between a plurality of the devices, e.g., within the cohort 104. A variety of other examples are also contemplated.

An assembly module 310 is then leveraged to assemble the filtered resource scores 304 into respective buckets 312 based on the resources (block 612). The assembly module 310, for instance, assembles the resource scores corresponding to respective resources into associated buckets 312. In an implementation, resources that are “filtered out” are added back into the buckets. A metadata generation module 314 is then employed to add metadata to describe whether the corresponding resource score corresponds to an individual (e.g., that provided the input) or are based on the collection of devices 106 in the cohort 104 as a whole.

Usage of at least one of the resources by the cohort 104 of devices 106 is controlled by a resource control module 316 based on the resource scores included in at least one respective bucket (block 614). A score, for instance, is calculated for each resource included in the bucket 312 based on a score of the item from different devices included in the cohort. This is usable to control a variety of functionality.

In a first example, the resource control module 316 controls which items of digital content 112 are transmitted to the cohort 104 of devices 106. Consider the illustrated example of a digital content search module 318 and the input involves a search. A search result 320 is configured including representation of digital content 112 to be provided to the devices 106 within the cohort 104 based on the buckets 312. This is usable, for instance, to provide recommendations of digital content 112 (e.g., of digital books, digital moves, webpages) to respective devices.

FIG. 5 depicts an example implementation 500 of digital content transmitted to a device by the resource control module 316. In this example, a user interface is shown having recommendations 502 of digital content based on the personal device 504 as well as recommendations 506 of digital content based on the cohort 508. This is marked in the user interface in this example based on the metadata generated by the metadata generation module 314. The user interface in this example also includes an option 510 to mark a particular resource of interest to the cohort, which causes this item to be included automatically and without further user intervention by the other devices 106 within the cohort 104, e.g., as part of recommendations provided to those devices.

In another example, the resource control module 316 is configured to control provisioning of hardware and software resources of computing devices of the service provider system 102 and/or the devices 106, e.g., to provide the digital content 112 as above, predict resource utilization, and so forth. The resource control module 316, for instance, determines which items and amounts of the items of digital content 112 are provided to respective devices and makes predictions of resource utilization based on that digital content, e.g., to stream additional digital content based on a recommendation, support digital service interaction via the network 108, and so on. Based on these predictions, the service provider system 102 provisions hardware resources 116 and/or software resources 118 (e.g., as part of load balancing) to improve efficiency in device operation. These techniques are also usable to control hardware and software resources at the device 106, themselves, e.g., based on execution of the digital content 112 at respective devices 106. A variety of other examples are also contemplated. As a result, the cohort management system 120 supports a variety of different usage scenarios that overcome conventional challenges involved device interaction with resources.

Example System and Device

FIG. 7 illustrates an example system generally at 700 that includes an example computing device 702 that is representative of one or more computing systems and/or devices that implement the various techniques described herein. This is illustrated through inclusion of the cohort management system 120. The computing device 702 is configurable, for example, as a server of a service provider, a device associated with a client (e.g., a client device), an on-chip system, and/or any other suitable computing device or computing system.

The example computing device 702 as illustrated includes a processing device 704, one or more computer-readable media 706, and one or more I/O interface 708 that are communicatively coupled, one to another. Although not shown, the computing device 702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 704 is representative of functionality to perform one or more operations using hardware. Accordingly, the processing device 704 is illustrated as including hardware element 710 that is configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712 that stores instructions that are executable to cause the processing device 704 to perform operations. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing device 704. The instructions and/or functions are executable/operable by one or more articles of manufacture (for example, one or more computing devices 702 and/or processing devices 704) to implement techniques, modules, and examples described herein.

The techniques described herein are supported by various configurations of the computing device 702 and are not limited to the specific examples of the techniques described herein. This functionality is also implementable all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In implementations, the platform 716 employs a “machine-learning model” that is configured to implement the techniques described herein. A machine-learning model refers to a computer representation that can be tuned (e.g., trained) based on inputs to approximate unknown functions. In particular, the term machine-learning model can include a model that utilizes algorithms to learn from, and make predictions on, known data by analyzing training data to learn to generate outputs that reflect patterns and attributes of the training data. Examples of machine-learning models include neural networks, convolutional neural networks (CNNs), long short-term memory (LSTM) neural networks, decision trees, and so forth.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a processing device, the method comprising:
detecting, by the processing device, a cohort of devices from a plurality of devices, the cohort having a shared characteristic that defines membership in the cohort;
obtaining, by the processing device, resource utilization data defining resource categories and including resource scores describing respective amounts of resource utilization by the cohort of devices;
filtering, by the processing device, the resource scores by removing resource scores of resources that are not identified as pertaining to shared involvement within the cohort of devices;
assembling, by the processing device, the filtered resource scores into respective buckets based on the resources; and
controlling, by the processing device, usage of at least one of the resources by the cohort of devices based on resource scores included in at least one said respective bucket.

2. The method as described in claim 1, wherein the detecting includes generating a cohort graph defining relationships of the devices within the cohort.

3. The method as described in claim 2, wherein the cohort graph is a probabilistic cohort graph or a deterministic cohort graph.

4. The method as described in claim 1, wherein the detecting includes detecting the shared characteristic that defines membership in the cohort using a machine-learning model trained using training data as part of machine learning.

5. The method as described in claim 1, further comprising generating the resource utilization data defining the resource categories and including the resource scores.

6. The method as described in claim 5, wherein the generating is performed using a machine-learning model trained using training data as part of machine learning.

7. The method as described in claim 1, further comprising determining, by the processing device, an amount of impact of the devices included in the cohort on the resource utilization, respectively, and wherein the resource scores associated with respective said devices are weighted based at least in part on this impact.

8. The method as described in claim 7, wherein the resource scores associated with respective said devices are weighted based on an influence of devices within the cohort and overall influence of the plurality of devices.

9. The method as described in claim 1, wherein the controlling includes controlling transmission of digital content to the cohort of devices via a network.

10. The method as described in claim 1, wherein the controlling includes provisioning hardware and software resources of computing devices of a service provider system.

11. A system comprising:
a cohort detection module implemented by a processing device to detect a cohort of devices from a plurality of user identifiers (IDs), the cohort having a shared characteristic that defines membership in the cohort;
a recommendation engine implemented by the processing device to generate resource utilization data including resource scores describing respective amounts of resource utilization by the cohort of user IDs;
a score filtering module implemented by the processing device to filter the resource scores by removing resource scores of resources that are not identified as pertaining to shared involvement within the cohort of user IDs;
a category assembly module implemented by the processing device to assemble the filtered resource scores into respective buckets based on the resources; and
a resource control module implemented by the processing device to control usage of at least one of the resources by the cohort of user IDs based on resource scores included in at least one said respective bucket.

12. The system as described in claim 11, wherein the cohort detection module utilizes a machine-learning model to detect the shared characteristic, the machine-learning model trained using training data as part of machine learning.

13. The system as described in claim 11, wherein the recommendation engine utilizes a machine-learning model to generate the resource scores, the machine-learning model trained using training data as part of machine learning.

14. The system as described in claim 11, further comprising an impact determination module implemented by the processing device to determine an amount of impact of the user IDs included in the cohort on the resource utilization, respectively, and wherein the resource scores associated with respective said user IDs are weighted based at least in part on this impact.

15. The system as described in claim 14, wherein the resource scores associated with respective said user IDs are weighted based on an influence of user IDs within the cohort and overall influence of the plurality of user IDs.

16. The system as described in claim 11, wherein the resource control module is configured to control transmission of digital content to the cohort of user IDs via a network.

17. The system as described in claim 11, wherein the resource control module is configured to control provisioning hardware and software resources of computing devices of a service provider system.

18. A non-transitory computer-readable storage medium storing instruction that, responsive to execution by a processing device, causes the processing device to perform operations including:
detecting a cohort of devices from a plurality of devices, the cohort having a shared characteristic that defines membership in the cohort;
obtaining resource utilization data including resource scores describing respective amounts of resource utilization by the cohort of devices;
assembling the resource scores into respective buckets based on the resources; and
controlling usage of at least one of the resources by the cohort of devices based on resource scores.

19. The computer-readable storage medium as described in claim 18, the detecting utilizes a machine-learning model to detect the shared characteristic, the machine-learning model trained using training data as part of machine learning.

20. The computer-readable storage medium as described in claim 18, wherein the obtaining utilizes a machine-learning model to generate the resource scores, the machine-learning model trained using training data as part of machine learning.
